(19) United States
(12) Patent Application Publication
(10) Pub. No.: US 2023/0023602 A1
(43) Pub. Date: Jan. 26, 2023

(54) ARITHMETIC PROCESSING DEVICE AND ARITHMETIC PROCESSING METHOD

(71) Applicant: FUJITSU LIMITED, Kawasaki-shi (JP)

(72) Inventors: MAKIKO ITO, Kawasaki (JP); Takahide Yoshikawa, Kawasaki (JP)

(73) Assignee: FUJITSU LIMITED, Kawasaki-shi (JP)

(21) Appl. No.: 17/699,217

(22) Filed: Mar. 21, 2022

(30) Foreign Application Priority Data
Jul. 16, 2021 (JP) 2021-118221

(51) Int. Cl. G06F 9/38

(52) U.S. Cl. CPC G06F 9/3836

(57) ABSTRACT

An arithmetic processing device that executes a single instruction/multiple data (SIMD) operation, includes a memory; and a processor coupled to the memory and configured to register an indefinite cycle instruction of a plurality of instructions to a first queue, register other instructions other than the indefinite cycle instruction of the plurality of instructions to a second queue, issue the indefinite cycle instruction registered to the first queue, and issue the other instructions registered to the second queue after issuing the indefinite cycle instruction.

### CROSS-REFERENCE TO RELATED APPLICATION

This application is based upon and claims the benefit of priority of the prior Japanese Patent Application No. 2021-118221, filed on Jul. 16, 2021, the entire contents of which are incorporated herein by reference.

### FIELD

The embodiment discussed herein is related to an arithmetic processing device and an arithmetic processing method.

### BACKGROUND

Processors of computers include a single instruction/multiple data (SIMD) processor and a superscalar processor. The SIMD processor performs an SIMD operation for executing a plurality of pieces of data at the same time in order to enhance an arithmetic performance. The superscalar processor schedules an instruction at the time of executing the instruction and issues instructions at the same time so as to enhance a processing performance.

Such an SIMD processor or a superscalar processor is used, for example, for graph processing and sparse matrix calculations. For example, the graph processing expresses a relationship between humans and things as a graph and performs analysis using a graph algorithm or search for an optimum solution. For example, the sparse matrix calculation solves a partial differential equation using a sparse matrix having many zero elements in a real application for numerical value calculations.

Japanese Laid-open Patent Publication No. 2010-073197 and U.S. Patent Application Publication No. 2019/0227805 are disclosed as related art.

### SUMMARY

According to an aspect of the embodiments, a arithmetic processing device that executes a single instruction/multiple data (SIMD) operation, includes a memory; and a processor coupled to the memory and configured to: register an indefinite cycle instruction of a plurality of instructions to a first queue, register other instructions other than the indefinite cycle instruction of the plurality of instructions to a second queue, issue the indefinite cycle instruction registered to the first queue, and issue the other instructions registered to the second queue after issuing the indefinite cycle instruction.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a sparse matrix and a dense vector and illustrating a program for accessing a product of the sparse matrix and the dense vector;

FIG. 2 is a diagram for explaining an access to the sparse matrix and the dense vector;

FIG. 3 is a diagram for explaining gather loading of an SIMD processor;

FIG. 4 is a diagram for explaining an operation example of a superscalar processor;

FIG. 5 is a diagram for explaining a structural example of a superscalar processor according to an embodiment;

FIG. 6 is a diagram for explaining data forward processing between instructions of the SIMD processor;

FIG. 7 is a diagram for explaining gather load processing in the SIMD processor;

FIG. 8 is a diagram for explaining a pipeline stall of the SIMD processor as a related example;

FIG. 9 is a diagram for explaining scheduling processing in consideration of an irregular memory access in the SIMD processor as the embodiment;

FIG. 10 is a diagram for explaining an operation of a scheduler in the SIMD processor as a related example;

FIG. 11 is a diagram for explaining an operation of a scheduler in the SIMD processor as the embodiment;

FIG. 12 is a block diagram schematically illustrating a hardware configuration example of an arithmetic processing device as the embodiment;

FIG. 13 is a logical block diagram schematically illustrating a hardware structure example of the scheduler as the related example;

FIG. 14 is a logical block diagram schematically illustrating a hardware structure example of the scheduler as the embodiment;

FIG. 15 is a flowchart for explaining an operation of the scheduler as the related example;

FIG. 16 is a flowchart for explaining an operation of the scheduler as the embodiment;

FIG. 17 is a flowchart for explaining an operation of instruction issuance from rdyQ;

FIG. 18 is a flowchart for explaining an operation of instruction issuance from vRdyQ; and

FIG. 19 is a flowchart for explaining an operation of a scheduler as a modification.

### DESCRIPTION OF EMBODIMENTS

In the related art, in the graph processing and the sparse matrix calculation, there is a possibility that an irregular memory access occurs in the SIMD operation. In the graph processing and the sparse matrix calculation, data is often loaded using an index of a connected destination vertex and an index of a non-zero element. In a case of continuous data, it is possible to load the data from a cache memory at once. On the other hand, in a case of the irregular memory access, individual pieces of data are loaded from the individual cache lines, the number of accesses to data is internally divided into a plurality of times.

In one aspect, an object is to reduce the number of times of pipeline stalls.

### [A] Embodiment

Hereinafter, an embodiment will be described with reference to the drawings. Note that the embodiment to be described below is merely an example, and there is no intention to exclude application of various modifications and techniques not explicitly described in the embodiment. In other words, for example, the present embodiment may be variously modified and implemented without departing from the scope of the gist thereof. Furthermore, each drawing is not intended to include only components illustrated in the drawing and may include another function and the like.

Hereinafter, each same reference represents a similar part in the drawings, and thus description thereof will be omitted.

### [A-1] Configuration Example

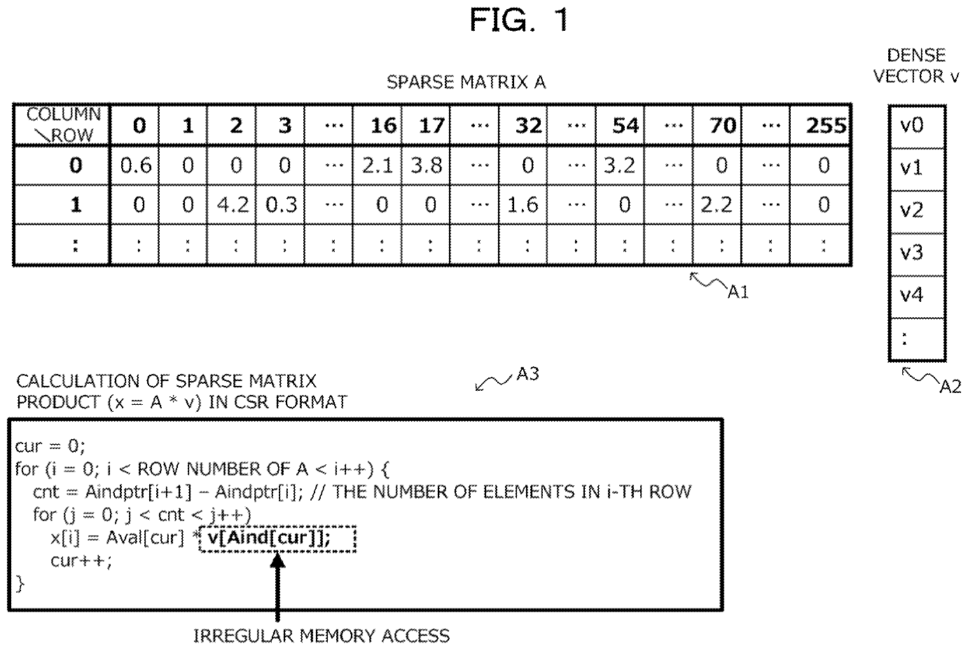

FIG. 1 is a diagram illustrating a sparse matrix and a dense vector and illustrating a program for accessing a product of the sparse matrix and the dense vector.

A sparse matrix A indicated by a reference A1 is a matrix including 256 rows and 256 columns. Furthermore, a dense vector v indicated by a reference A2 is a matrix including 256 elements.

The sparse matrix A may be represented in a compressed sparse row (CSR) format and a compressed format from which zeros are deleted. As arrays of values, the CSR format includes an array Aval of values of the sparse matrix A indicating values of data other than zero, an array Aind of indexes of the sparse matrix A indicating a column number including data other than zero, and Aindptr indicating a delimiter of a row including the data other than zero in Aval and Aind.

In the example illustrated in FIG. 1, the sparse matrix A is Aval=[0.6, 2.1, 3.8, 3.2, 4.2, 0.3, 1.6, . . . ], Aind=[0, 16, 17, 54, 2, 3, 32, 70, . . . ], and Aindptr=[0, 4, 8, . . . ].

In a general matrix product x=A*v, in a case where the matrix A includes m rows and n columns and the number of elements of the vector v is n, the number of the elements of the matrix product x is m, and the following expression is satisfied.

$${x}_{0} = {\sum }_{j = 0}^{N - 1} {A}_{i , j} \cdot {v}_{j} \qquad [ Expression 1 ]$$

In an arithmetic program of the sparse matrix product (x=A*v) in the CSR format indicated by a reference A3, “v [Aind [cur]];” indicated by a reference A31 is an irregular memory access.

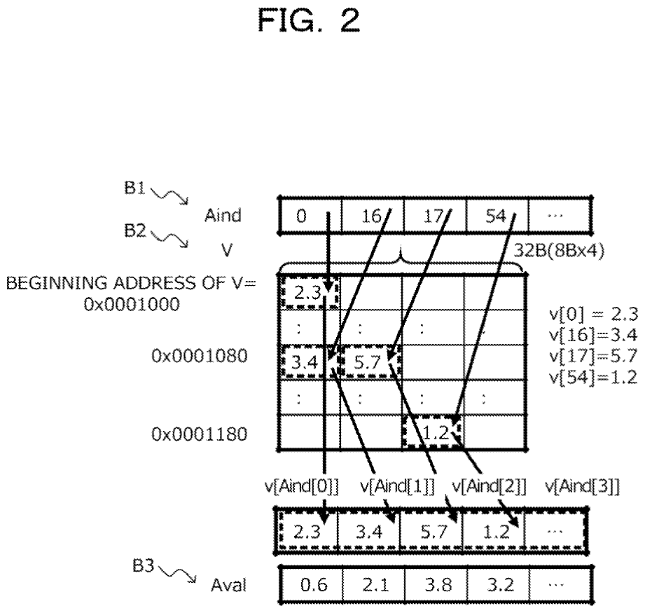

FIG. 2 is a diagram for explaining an access to a sparse matrix and a dense vector.

In the program indicated by the reference A3 in FIG. 1, as illustrated in FIG. 2, in addition to an array Aind of an index in a sparse matrix A indicated by a reference B1 and an array Aval of a value of a sparse matrix A indicated by a reference B3, an array of a dense vector v that is double-precision data (8B) as indicated by a reference B2 is referred. In the example illustrated in FIG. 2, in the array of the dense vector v, v [0]=2.3 is stored in a beginning address of v=0x0001000, v [16]=3.4 is stored in an address=0x0001080, v [17]=5.7 is stored in an address=0x0001088, and v [54]=1.2 is stored in an address=0x0001180.

Then, using v [0], v [16], v [17], v [54] as a single array u, a product with the array Aval is obtained.

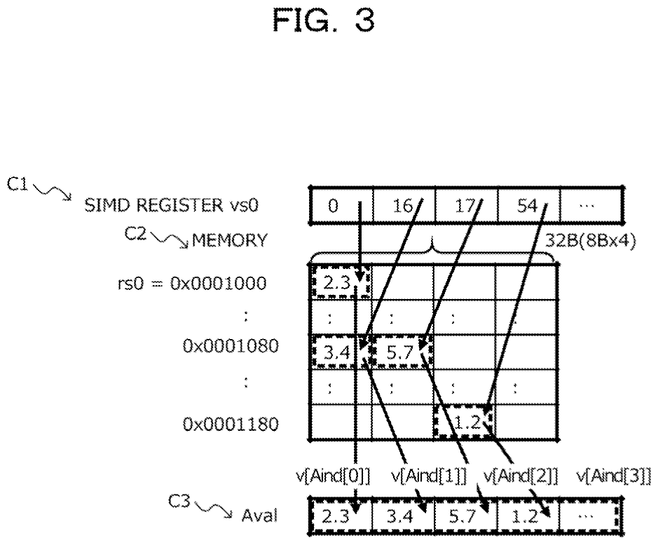

FIG. 3 is a diagram for explaining gather loading of an SIMD processor.

In the SIMD processor illustrated in FIG. 3, an array vs0=[0, 16, 17, 54] is stored in an SIMD register indicated by a reference C1. In a memory indicated by a reference C2, 2.3 is stored in 0x0001000, 3.4 is stored in 0x0001080, 5.7 is stored in 0x0001088, and 1.2 is stored in 0x0001180. Furthermore, an address 0x0001000 is stored in a scalar register rs0. Then, as indicated by a reference C3, in the SIMD register, a value of the memory is gather loaded (in other words, index load), and vd0=[2.3, 3.4, 5.7, 1.2] is stored.

In this way, in the SIMD processor, data is loaded with each element of an SIMD register vs0 as an index for a base address (rs0), and the loaded data is stored in the SIMD register vd0. The SIMD processor needs a plurality of cycles of accesses in order to access a plurality of cache lines.

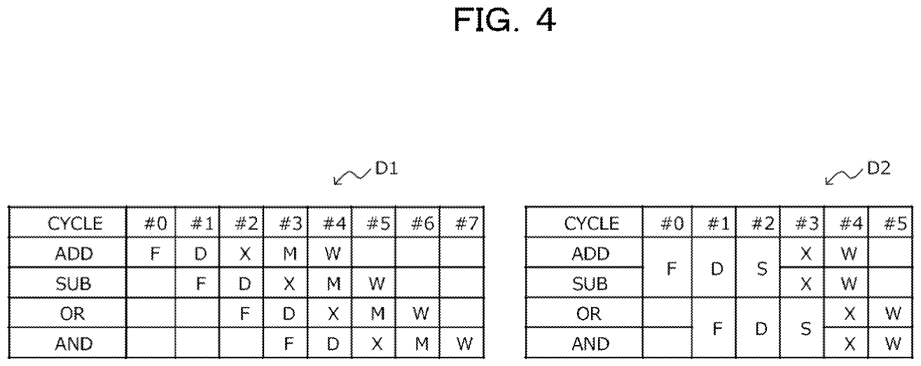

FIG. 4 is a diagram for explaining an operation example of a superscalar processor.

In the superscalar processor, hardware analyzes a dependency between instructions, dynamically determines an execution order and allocation of execution units, and executes processing. In the superscalar processor, a plurality of memory accesses and calculations are performed at the same time.

In a five-stage pipeline indicated by a reference D1, one instruction is divided into five steps, each step is executed in one clock cycle, and parallel processing is partially executed so that one instruction is executed in one cycle in appearance.

In the example illustrated by the reference D1, in response to each instruction such as ADD, SUB, OR, or AND, processing in steps #0 to #5 is executed. In step #0, an instruction is fetched (F) from an instruction cache, and in step #1, the instruction is decoded (in other words, decoded or translated) (D). In step #2, an operation is executed (X), in step #3, the memory is accessed (M), and in step #4, a result is written (W).

In a five-stage superscalar indicated by a reference D2, two pipelines are processed at the same time, and two instructions are dually executed in one cycle. In the five-stage superscalar, in processing in steps #3 and #4 of processing in steps #0 to #4 of the five-stage pipeline, two instructions are executed in one cycle.

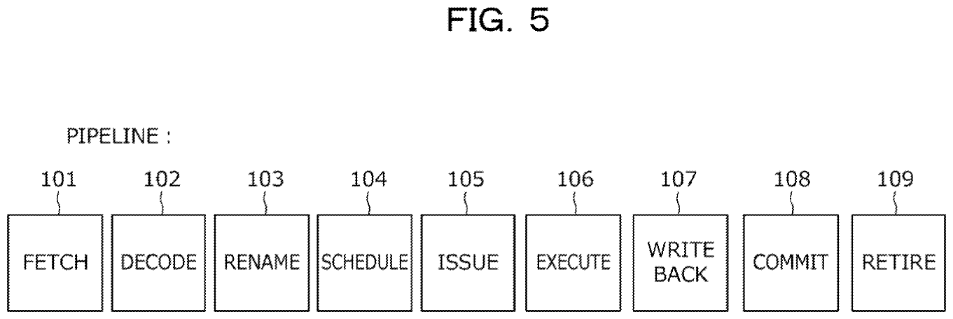

FIG. 5 is a diagram for explaining a structural example of a superscalar processor according to the embodiment.

The superscalar processor illustrated in FIG. 5 includes each processing including Fetch 101, Decode 102, Rename 103, Schedule 104, Issue 105, Execute 106, WriteBack 107, Commit 108, and Retire 109.

Fetch 101 acquires an instruction from a memory. Decode 102 decodes the instruction. Rename 103 allocates a physical register to a logical register and dispatches an issue queue.

Schedule 104 issues the instruction to a backend and dynamically determines an execution order and allocation of execution units. Schedule 104 concurrently issues irregular memory access instructions as many as possible in order to reduce pipeline stalls due to irregular memory accesses. Specifically, for example, Schedule 104 searches for a list of the dispatched instructions and performs prediction from an execution history.

Each processing of Execute 106, WriteBack 107, Commit 108, and Retire 109 including Issue 105 functions as backends.

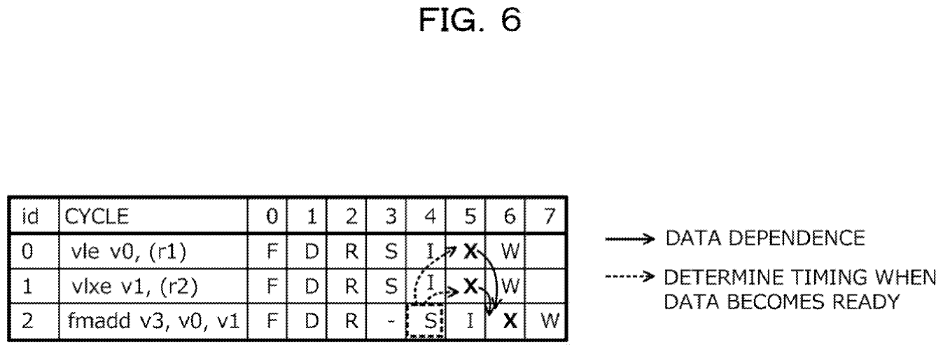

FIG. 6 is a diagram for explaining data forward processing between instructions of the SIMD processor.

In the tables illustrated in FIGS. 6 to 9, F indicates processing by Fetch 101, D indicates processing by Decode 102, R indicates processing by Rename 103, S indicates processing by Schedule 104, I indicates processing by Issue 105, X indicates processing by Execute 106, and W indicates processing by WriteBack 107.

In the forward processing illustrated in FIG. 6, at the stage of Schedule 104, a data dependency is analyzed, data is forwarded between instructions (in other words, bypass) so as not to delay execution of the instruction.

In FIG. 6, an instruction vle v0, (r1) with an id 0, an instruction vlxe v1, (r2) with an id1, and an instruction fmadd v3, v0, v1 with an id 2 are included. In the cycle #4 with the id 2, Schedule 104 determines a timing when data becomes Ready for Execute 106 in the cycles #5 with the ids 0 and 1. Data of Execute 106 in the cycles #5 with the ids 0 and 1 is dependent on Execute 106 in the cycle #6 with the id 2.

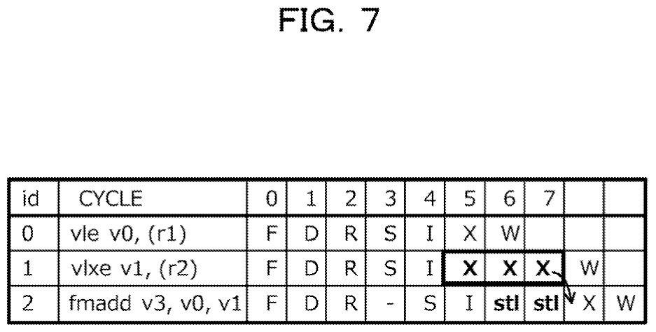

FIG. 7 is a diagram for explaining gather load processing in the SIMD processor.

In FIG. 7, an instruction vle v0, (r1) with the id 0, an instruction vlxe v1, (r2) with the id 1, and an instruction fmadd v3, v0, v1 with the id 2 are included. In the access of the gather load processing as illustrated in FIG. 3, as indicated in steps #5 to #7 with the id 1 in FIG. 7, Execute 106 needs to perform three cycles of gather loading. As a result, stall (stl) occurs in steps #6 and #7 with the id 2.

In this way, because Schedule 104 can determine a timing for transferring data, when unexpected wait occurs, an entire backend stalls.

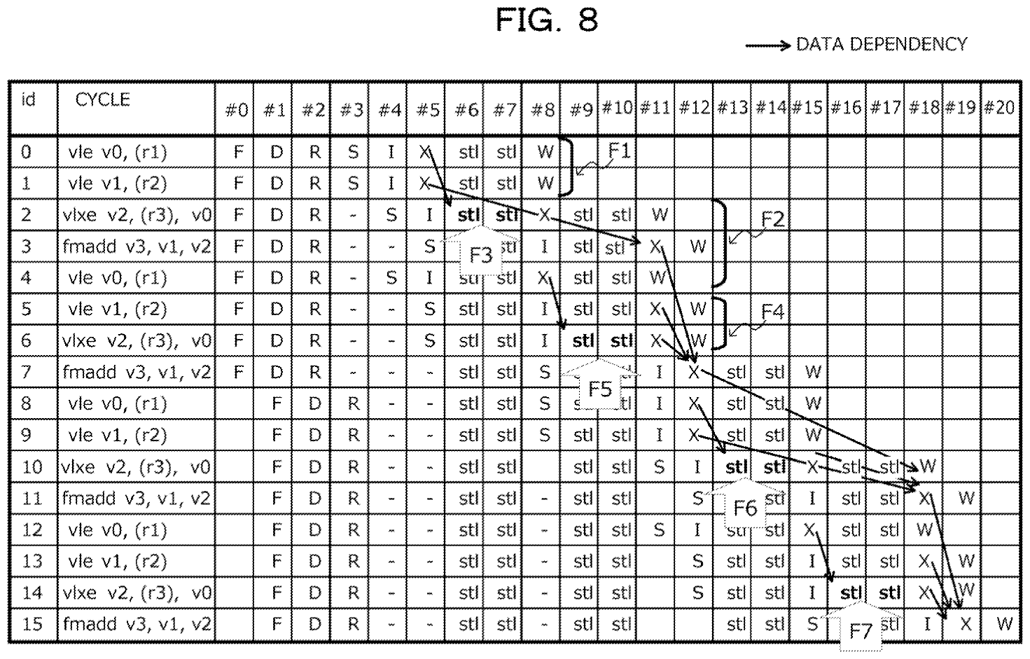

FIG. 8 is a diagram for explaining a pipeline stall of the SIMD processor as a related example.

In FIG. 8, ids 0, 4, 8, and 12 include vle v0, (r1) that is a sparse matrix index data load (continuous load), and ids 1, 5, 9, and 13 include vle v1, (r2) that is a sparse matrix data load (continuous load). Furthermore, ids 2, 6, 10, and 14 include vlxe v2, (r3), v0 that is a vector gather load (collision with index dependence), ids 3, 7, 11, and 15 include fmadd v3, v1, v2 that is a sum of products. In the example illustrated in FIG. 8, it is assumed that there are two LDST/Float units each, and two LDST/product-sum operations can be executed at the same time.

As indicated by a reference F1, two continuous loads are performed in the ids 0 and 1. The gather load in the id 2 indicated by a reference F2 in addition to the continuous load causes stalls (Stl) in the cycles #6 and #7 as indicated by a reference F3. Furthermore, the gather load in the id 6 indicated by a reference F4 in addition to the continuous load causes stalls in the cycles #9 and #10 as indicated by a reference F5. Similarly, a stall occurs in the id 10 as indicated by a reference F6, and a stall occurs in the id 14 as indicated by a reference F7.

In this way, the stalls frequently occur due to multiple-cycle memory accesses caused by gather loading. When a stall occurs, the entire pipeline stops, and a performance deteriorates.

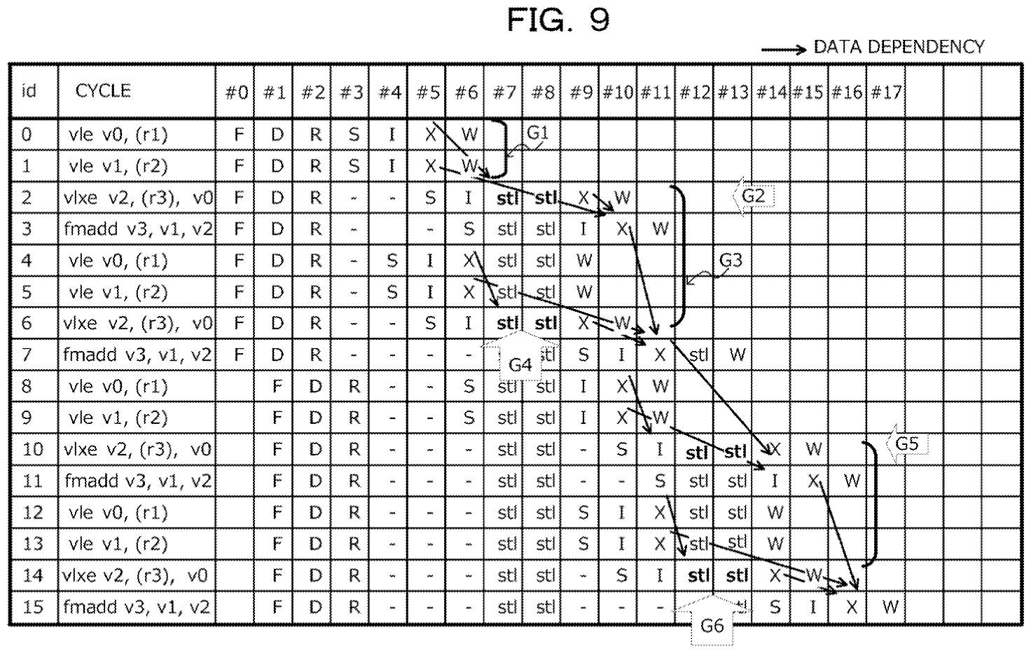

FIG. 9 is a diagram for explaining scheduling processing in consideration of an irregular memory access in the SIMD processor as the embodiment.

In FIG. 9, ids 0, 4, 8, and 12 include vle v0, (r1) that is an index load (continuous load), and ids 1, 5, 9, and 13 include vle v1, (r2) that is a sparse matrix data load (continuous load). Furthermore, ids 2, 6, 10, and 14 include vlxe v2, (r3), v0 that is a vector gather load (collision with index dependence), ids 3, 7, 11, and 15 include fmadd v3, v1, v2 that is a sum of products.

As indicated by a reference G1, two continuous loads are performed in the ids 0 and 1. As indicated by a reference G2, processing of Schedule 104 in the id 2 is delayed from the cycle #4 to the cycle #5. The gather load in the ids 2 and 6 indicated by a reference G3 causes stalls (Stl) in the cycles #7 and #8 as indicated by a reference G4. Similarly, by delaying an instruction in the id 10 as indicated by a reference G5, a stall occurs in the id 14 as indicated by a reference G6.

In this way, the number of stalls can be reduced by collecting the gather loads.

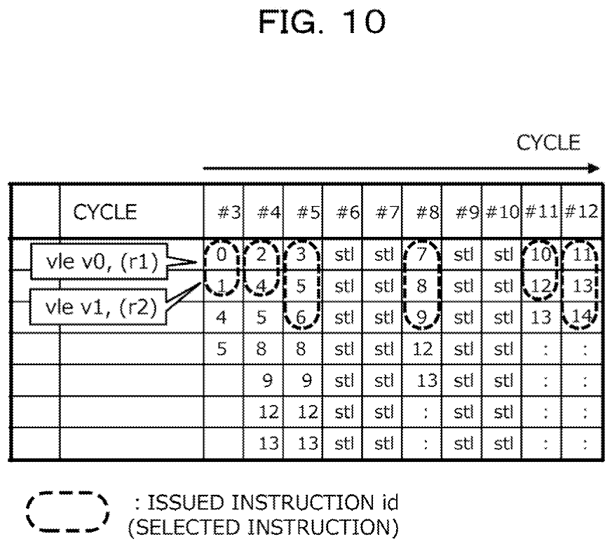

FIG. 10 is a diagram for explaining an operation of a scheduler in the SIMD processor as a related example.

The scheduler checks a dependency between instructions and adds an issuable instruction to readyQueue. The scheduler issues instructions of readyQueue in a range in which resources can be secured in a fetching order.

In FIG. 10, for example, in the cycle #3, instructions in the ids 0, 1, 4, and 5 are included in redyQueue. A dashed frame indicates an instruction id issued in each cycle (in other words, selected instruction).

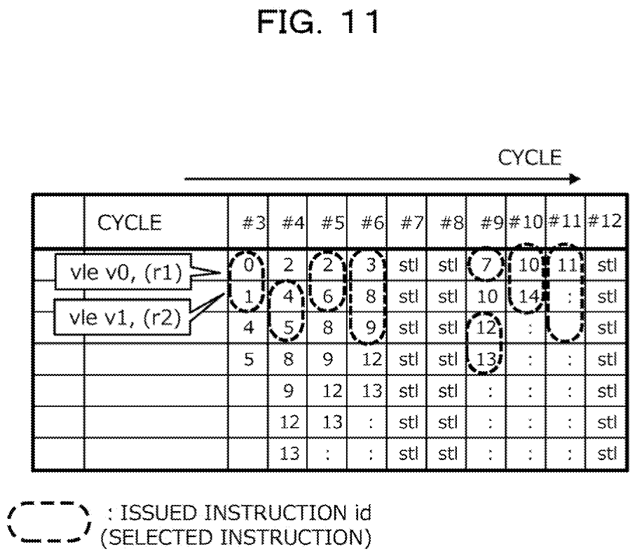

FIG. 11 is a diagram for explaining an operation of a scheduler in the SIMD processor as the embodiment.

The scheduler checks a dependency between instructions and adds an issuable instruction to readyQueue. The scheduler issues instructions of readyQueue in a range in which resources can be secured from the beginning in a fetching order. At that time, the scheduler confirms whether or not an instruction x having an indefinite number of cycles (for example, gather load) can be set with an equivalent instruction y. When it is possible to set with the equivalent instruction y, the scheduler delays issuance until the instruction y can be issued. As a method for searching for the instruction y, there are a method for searching for a list of dispatched instructions, a method for performing prediction from a history, or the like.

In FIG. 11, for example, in the cycle 3, instructions in the ids 0, 1, 4, and 5 are included in readyQueue. A dashed frame indicates an instruction id issued in each cycle (in other words, selected instruction).

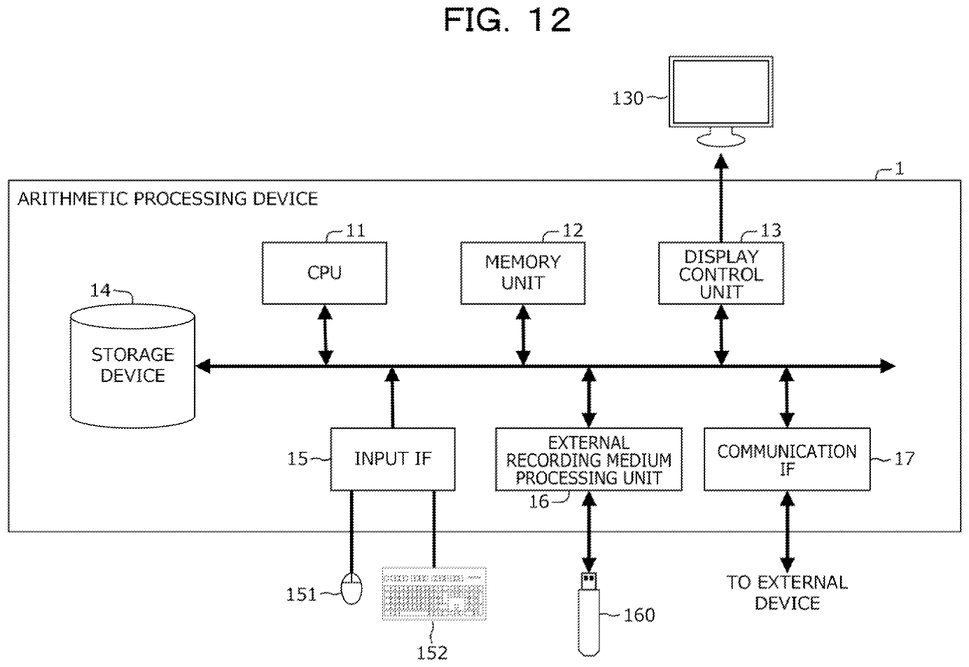

FIG. 12 is a block diagram schematically illustrating a hardware structure example of the arithmetic processing device 1 as an embodiment.

As illustrated in FIG. 12, the arithmetic processing device 1 has a server function, and includes a central processing unit (CPU) 11, a memory unit 12, a display control unit 13, a storage device 14, an input interface (IF) 15, an external recording medium processing unit 16, and a communication IF 17.

The memory unit 12 is one example of a storage unit, which is, for example, a read only memory (ROM), a random access memory (RAM), and the like. Programs such as a basic input/output system (BIOS) may be written into the ROM of the memory unit 12. A software program of the memory unit 12 may be appropriately read and executed by the CPU 11. Furthermore, the RAM of the memory unit 12 may be used as a temporary recording memory or a working memory.

The display control unit 13 is connected to a display device 130 and controls the display device 130. The display device 130 is a liquid crystal display, an organic light-emitting diode (OLED) display, a cathode ray tube (CRT), an electronic paper display, or the like, and displays various kinds of information for an operator or the like. The display device 130 may also be combined with an input device and may also be, for example, a touch panel.

The storage device 14 is a storage device having high input/output (I0) performance, and for example, a dynamic random access memory (DRAM), a solid state drive (SSD), a storage class memory (SCM), or a hard disk drive (HDD) may be used.

The input IF 15 may be connected to an input device such as a mouse 151 or a keyboard 152, and may control the input device such as the mouse 151 or the keyboard 152. The mouse 151 and the keyboard 152 are examples of the input devices, and an operator performs various kinds of input operation through these input devices.

The external recording medium processing unit 16 is configured to have a recording medium 160 attachable thereto. The external recording medium processing unit 16 is configured to be capable of reading information recorded in the recording medium 160 in a state where the recording medium 160 is attached thereto. In the present example, the recording medium 160 is portable. For example, the recording medium 160 is a flexible disk, an optical disk, a magnetic disk, a magneto-optical disk, a semiconductor memory, or the like.

The communication IF 17 is an interface for enabling communication with an external device.

The CPU 11 is one example of a processor, and is a processing device that performs various controls and calculations. The CPU 11 implements various functions by executing an operating system (OS) or a program read by the memory unit 12.

A device for controlling an operation of the entire arithmetic processing device 1 is not limited to the CPU 11 and may also be, for example, any one of an MPU, a DSP, an ASIC, a PLD, or an FPGA. Furthermore, the device for controlling the operation of the entire arithmetic processing device 1 may also be a combination of two or more of the CPU, MPU, DSP, ASIC, PLD, and FPGA. Note that the MPU is an abbreviation for a micro processing unit, the DSP is an abbreviation for a digital signal processor, and the ASIC is an abbreviation for an application specific integrated circuit. Furthermore, the PLD is an abbreviation for a programmable logic device, and the FPGA is an abbreviation for a field programmable gate array.

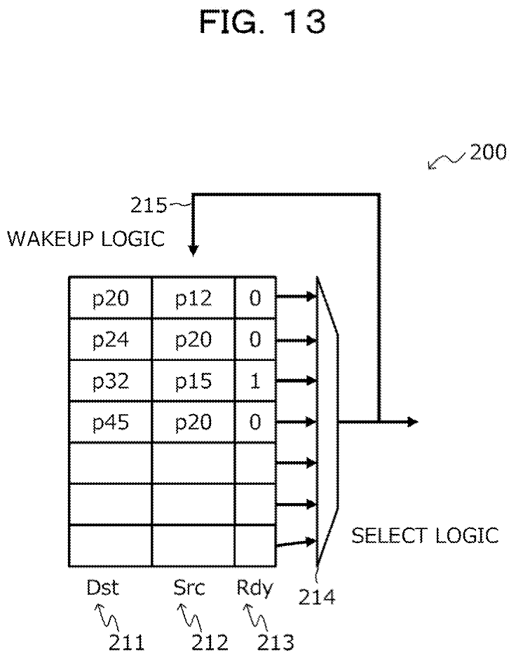

FIG. 13 is a logical block diagram schematically illustrating a hardware structure example of a scheduler 200 as a related example.

The scheduler 200 includes a Dst 211, a Src 212, a Rdy 213, a select logic 214, and a wakeup logic 215.

Outputs from the Dst 211, the Src 212, and the Rdy 213 are input to the select logic 214. An output from the select logic 214 is output from the scheduler 200 and is input to the Dst 211, the Src 212, and the Rdy 213.

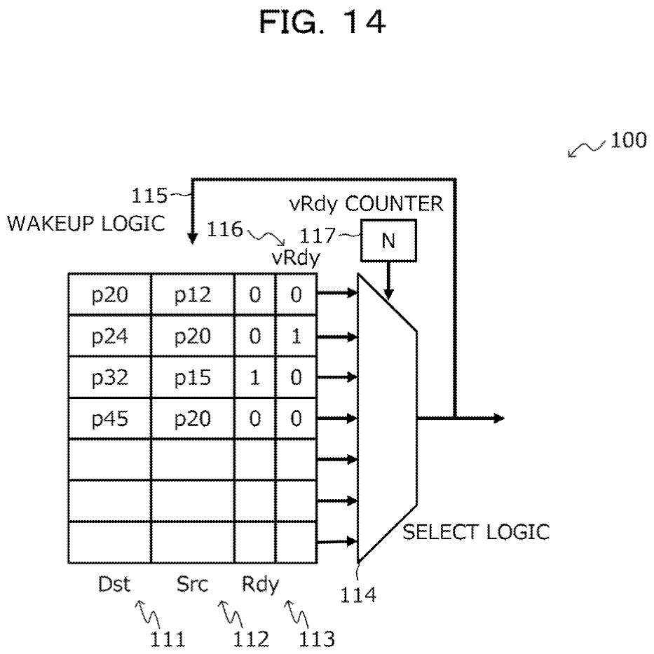

FIG. 14 is a logical block diagram schematically illustrating a hardware structure example of a scheduler 100 as an embodiment.

The scheduler 100 includes a Dst 111, a Src 112, a Rdy 113 (in other words, second queue), a select logic 114, a wakeup logic 115, a vRdy 116 (in other words, second queue), and a vRdy counter 117. The Dst 111, the Src 112, the Rdy 113, the select logic 114, and the wakeup logic 115 perform operations respectively similar to those of the Dst 211, the Src 212, the Rdy 213, the select logic 214, and the wakeup logic 215.

At a stage when an instruction is added to the vRdy 116, N is set to the vRdy counter 117. When an instruction in which a bit of the vRdy 116 is one exists, a value of the vRdy counter 117 is counted down at each cycle. On the other hand, when a plurality of instructions of which a bit of the vRdy 116 is one exists or when the value of the vRdy counter 117 is zero, the instruction of the vRdy 116 is selected. Then, when the instruction of the vRdy 116 is selected, N is set to the vRdy counter 117.

In other words, the scheduler 100 registers an indefinite cycle instruction of the plurality of instructions to the vRdy 116 and registers other instructions other than the indefinite cycle instruction of the plurality of instructions to the Rdy 113. The scheduler 100 issues the indefinite cycle instruction registered to the vRdy 116 and issues the other instructions registered to the Rdy 113 after the issuance of the indefinite cycle instruction.

When a certain period of time has elapsed after the indefinite cycle instruction has been registered to the vRdy 116, the scheduler 100 may issue the indefinite cycle instruction registered to the vRdy 116. Furthermore, when the plurality of indefinite cycle instructions is registered to the vRdy 116, the scheduler 100 may issue the indefinite cycle instructions in the fetching order from the vRdy 116.

When the indefinite cycle instruction exists in the list of the dispatched instructions, the scheduler 100 may register the indefinite cycle instruction to the vRdy 116.

[A-2] Operation Example

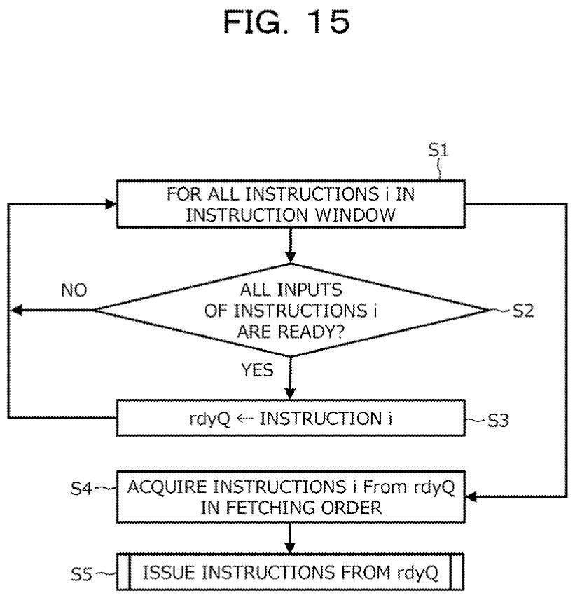

The operation of the scheduler 200 as the related example will be described according to the flowchart (steps S1 to S5) illustrated in FIG. 15.

The scheduler 200 repeats processing in steps S2 and S3 for all instructions i in an instruction window (step S1).

The scheduler 200 determines whether or not all inputs of the instruction i are Ready (step S2).

In a case where there is an input of the instruction i that is not Ready (refer to No route in step S2), the processing returns to step S1.

On the other hand, when all the inputs of the instructions i are Ready (refer to Yes route in step S2), the scheduler 200 sets the instruction i to rdyQ (readyQueue) (step S3).

When the processing in steps S2 and S3 is completed for all the instructions i in the instruction window, the scheduler 200 acquires the instructions i from rdyQ in the fetching order (step S4).

The scheduler 200 issues the instruction from rdyQ (step S5).

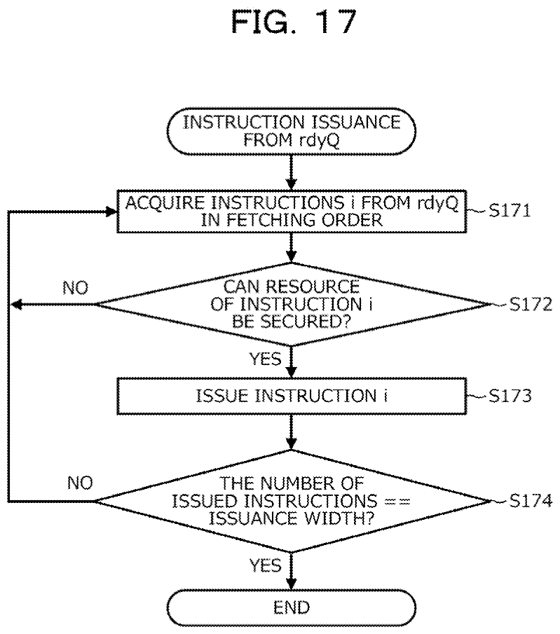

Details of the processing in step S5 will be described later with reference to FIG. 17. Then, the operation of the scheduler 200 is completed.

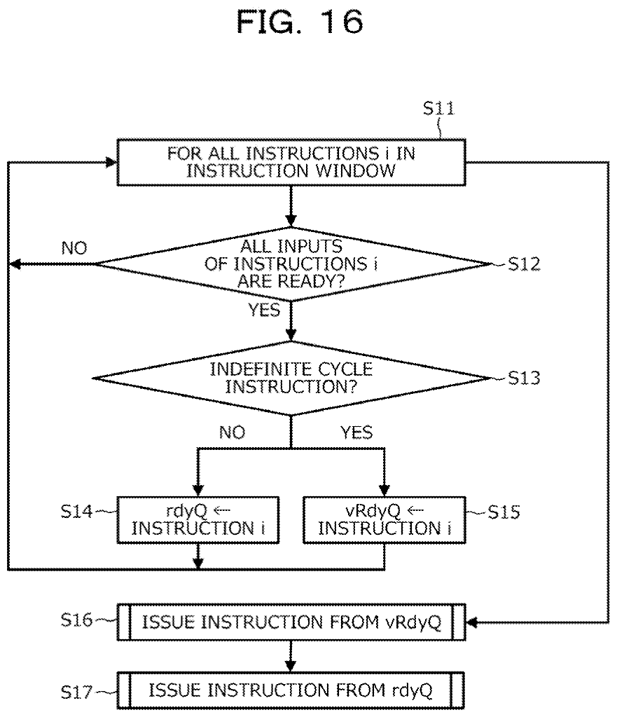

Next, an operation of the scheduler 100 as the embodiment will be described according to the flowchart (steps S11 to S17) illustrated in FIG. 16.

The scheduler 100 repeats processing in steps S12 to S15 for all the instructions i in the instruction window (step S11).

The scheduler 100 determines whether or not all inputs of the instructions i are Ready (step S12).

When there is an input of the instruction i that is not Ready (refer to No route in step S12), the processing returns to step S11.

On the other hand, when all the inputs of the instructions i are Ready (refer to Yes route in step S12), the scheduler 100 determines whether or not the instruction i is an indefinite cycle instruction (step S13).

When the instruction i is not the indefinite cycle instruction (refer to No route in step S13), the scheduler 100 sets the instruction i to the rdyQ (step S14).

On the other hand, when the instruction i is the indefinite cycle instruction (refer to Yes route in step S13), the scheduler 100 sets the instruction i to the vRdyQ (readyQueue for indefinite cycle instruction) (step S15).

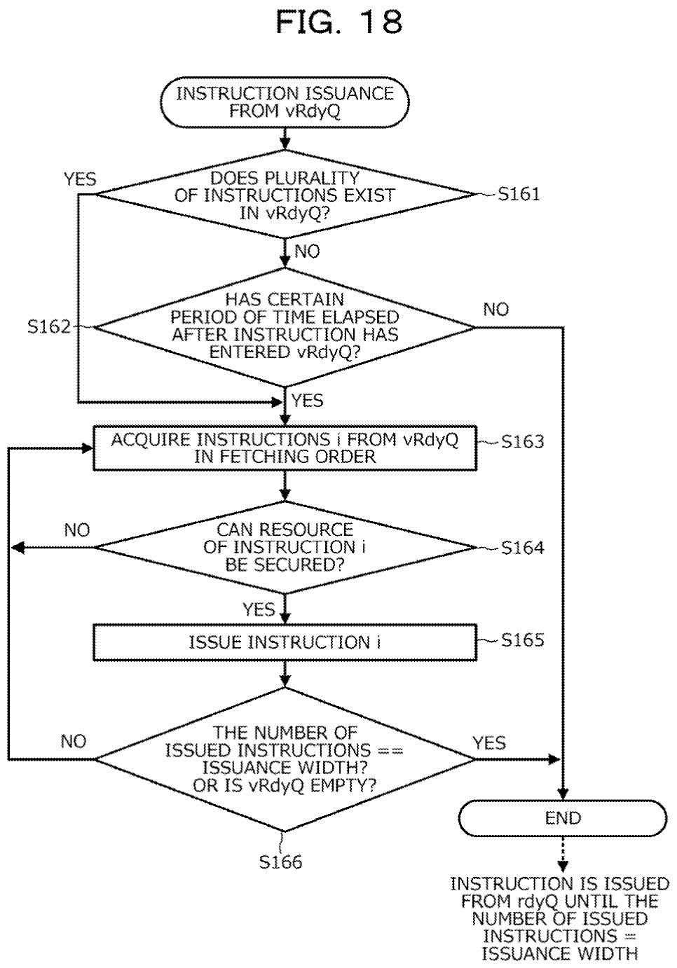

When the processing in steps S12 to S15 is completed for all the instructions i in the instruction window, the scheduler 100 issues an instruction from the vRdyQ (step S16). Details of the processing in step S16 will be described later with reference to FIG. 18.

The scheduler 100 issues an instruction from the rdyQ (step S17). Details of the processing in step S17 will be described later with reference to FIG. 17.

Next, an operation of instruction issuance from the rdyQ will be described according to the flowchart (steps S171 to S174) illustrated in FIG. 17.

Hereinafter, although processing by the scheduler 100 as the embodiment will be described, processing by the scheduler 200 as the related example is similar.

The scheduler 100 acquires instructions i from the rdyQ in the fetching order (step S171).

The scheduler 100 determines whether or not a resource of the instruction i can be secured (step S172).

When it is not possible to secure the resource of the instruction i (refer to No route in step S172), the processing returns to step S171.

On the other hand, when the resource of the instruction i can be secured (refer to Yes route in step S172), the scheduler 100 issues the instruction i (step S173).

The scheduler 100 determines whether or not the number of issued instructions is equal to an issuance width (step S174).

When the number of issued instructions is not equal to the issuance width (refer to No route in step S174), the processing returns to step S171.

On the other hand, when the number of issued instructions is equal to the issuance width (refer to Yes route in step S174), the instruction issuance processing from the rdyQ ends.

Next, an operation of instruction issuance from the vRdyQ will be described according to the flowchart (steps S161 to S166) illustrated in FIG. 18.

The scheduler 100 determines whether or not a plurality of instructions exists in the vRdyQ (step S161).

When the plurality of instructions exists in the vRdyQ (refer to Yes route in step S161), the processing proceeds to step S163.

On the other hand, when the plurality of instructions does not exist in the vRdyQ (refer to No route in step S161), the scheduler 100 determines whether or not a certain period of time has elapsed after the instruction has entered the vRdyQ (step S162).

When the certain period of time has not elapsed after the instruction has entered the vRdyQ (refer to No route in step S162), the instruction issuance from the vRdyQ ends. Thereafter, the instruction is issued from the rdyQ until the number of issued instructions becomes equal to the issuance width.

On the other hand, when the certain period of time has elapsed after the instruction has entered the vRdyQ (refer to Yes route in step S162), the scheduler 100 acquires the instructions i from the vRdyQ in the fetching order (step S163).

The scheduler 100 determines whether or not a resource of the instruction i can be secured (step S164).

When it is not possible to secure the resource of the instruction i (refer to No route in step S164), the processing returns to step S163.

On the other hand, when the resource of the instruction i can be secured (refer to Yes route in step S164), the scheduler 100 issues the instruction i (step S165).

The scheduler 100 determines whether or not the number of issued instructions is equal to the issuance width or the vRdyQ is empty (step S166).

When the number of issued instructions is not equal to the issuance width and the vRdyQ is not empty (refer to No route in step S166), the processing returns to step S163.

On the other hand, when the number of issued instructions is equal to the issuance width or the vRdyQ is empty (refer to Yes route in step S166), the instruction issuance from the vRdyQ ends. Thereafter, the instruction is issued from the rdyQ until the number of issued instructions becomes equal to the issuance width.

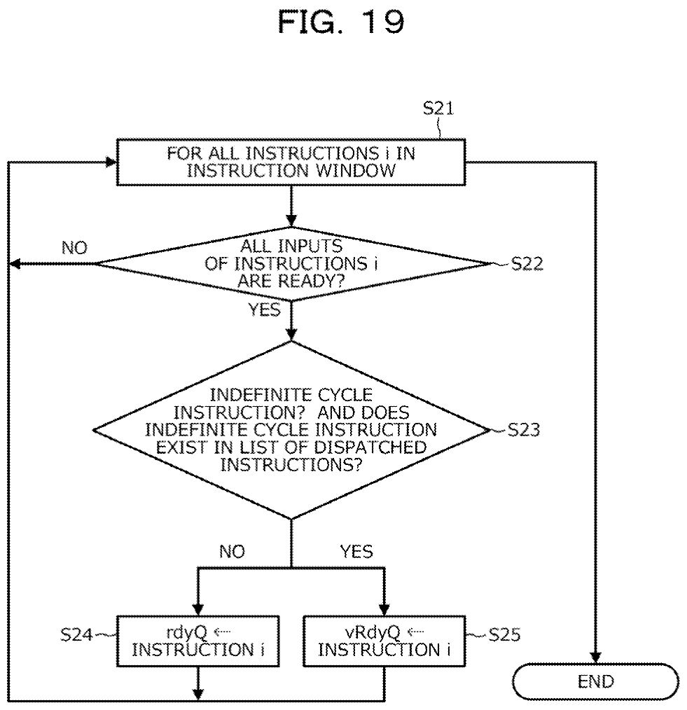

Next, an operation of a scheduler as a modification will be described according to the flowchart (step S21 to S25) illustrated in FIG. 19.

The scheduler 100 repeats processing in step S22 to S25 for all instructions i in the instruction window (step S21).

The scheduler 100 determines whether or not all inputs of the instructions i are Ready (step S22).

When there is an input of the instruction i that is not Ready (refer to No route in step S22), the processing returns to step S21.

On the other hand, when all the inputs of the instructions i are Ready (refer to Yes route in step S22), the scheduler 100 determines whether or not the instruction i is an indefinite cycle instruction and the indefinite cycle instruction exists in a list of dispatched instructions (step S23).

When the instruction i is not the indefinite cycle instruction or the indefinite cycle instruction does not exist in the list of dispatched instructions (refer to No route in step S23), the scheduler 100 sets the instruction i to the rdyQ (step S24).

On the other hand, when the instruction i is the indefinite cycle instruction and the indefinite cycle instruction exists in the list of dispatched instructions (refer to Yes route in step S23), the scheduler 100 sets the instruction i to the vRdyQ (step S25).

When the processing in steps S22 to S25 is completed for all the instructions i in the instruction window, the operation of the scheduler 100 as the modification ends.

[B] Effects

According to the arithmetic processing device 1 and the arithmetic processing method according to the embodiment described above, for example, the following effects may be obtained.

The scheduler 100 registers an indefinite cycle instruction of the plurality of instructions to the vRdy 116 and registers other instructions other than the indefinite cycle instruction of the plurality of instructions to the Rdy 113.

The scheduler 100 issues the indefinite cycle instruction registered to the vRdy 116 and issues the other instructions registered to the Rdy 113 after the issuance of the indefinite cycle instruction.

As a result, the number of times of pipeline stalls can be reduced. Specifically, for example, by collecting the gather loads, the number of times of stalls can be reduced.

[C] Others

The disclosed technology is not limited to the embodiment described above, and various modifications may be made without departing from the spirit of the present embodiment. Each of the configurations and processes according to the present embodiment may be selected as needed, or may also be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing device that executes a single instruction/multiple data (SIMD) operation, comprising:
a memory; and
a processor coupled to the memory and configured to:
register an indefinite cycle instruction of a plurality of instructions to a first queue,
register other instructions other than the indefinite cycle instruction of the plurality of instructions to a second queue,
issue the indefinite cycle instruction registered to the first queue, and
issue the other instructions registered to the second queue after issuing the indefinite cycle instruction.

2. The arithmetic processing device according to claim 1, wherein the processor issues, when a certain period of time has elapsed after the indefinite cycle instruction is registered to the first queue, the indefinite cycle instruction registered to the first queue.

3. The arithmetic processing device according to claim 1, wherein the processor issues, when a plurality of indefinite cycle instructions including the indefinite cycle instruction are registered to the first queue, the plurality of indefinite cycle instructions from the first queue in a fetching order.

4. The arithmetic processing device according to claim 1, wherein the processor registers, when the indefinite cycle instruction exists in a list of dispatched instructions, the indefinite cycle instruction to the first queue.

5. An arithmetic processing method performed by computer that executes a single instruction/multiple data (SIMD) operation, the operation processing method comprising:
registering an indefinite cycle instruction of a plurality of instructions to a first queue,
registering other instructions other than the indefinite cycle instruction of the plurality of instructions to a second queue,
issuing the indefinite cycle instruction registered to the first queue, and
issuing the other instructions registered to the second queue after issuing the indefinite cycle instruction.

6. The arithmetic processing method according to claim 5, wherein the issuing the indefinite cycle instruction includes issuing, when a certain period of time has elapsed after the indefinite cycle instruction is registered to the first queue, the indefinite cycle instruction registered to the first queue.

7. The arithmetic processing method according to claim 5, wherein the issuing the indefinite cycle instruction includes issuing, when a plurality of indefinite cycle instructions including the indefinite cycle instruction are registered to the first queue, the plurality of indefinite cycle instructions from the first queue in a fetching order.

8. The arithmetic processing method according to claim 5, wherein the registering the indefinite cycle instruction includes registering, when the indefinite cycle instruction exists in a list of dispatched instructions, the indefinite cycle instruction to the first queue.
